(19) United States
(12) Patent Application Publication
(10) Pub. No.: US 2023/0397213 A1
(43) Pub. Date: Dec. 7, 2023

(54) PUCCH RESOURCES FOR APERIODIC CHANNEL STATE INFORMATION

(71) Applicant: Telefonaktiebolaget LM Ericsson (PUBL), Stockholm (SE)

(72) Inventors: Yufei Blankenship, KILDEER, IL (US); Zhipeng Lin, NANJING Jiangsu (CN); Shiwei Gao, NEPEAN (CA); Jonas Fröberg Olsson, LJUNGSBRO (CA); Siva Muruganathan, STITTSVILLE (CA); Sorour Falahati, STOCKHOLM (SE)

(21) Appl. No.: 18/248,710

(22) PCT Filed: Oct. 12, 2021
(86) PCT No.: PCT/IB2021/059372

§ 371 Date: Apr. 12, 2023

(30) Foreign Application Priority Data
Oct. 12, 2020 (WO) PCT/CN2020/120507

(51) Int. Cl. H04W 72/21; H04W 24/10

(52) U.S. Cl. CPC H04W 72/21; H04W 24/10

(57) ABSTRACT

According to some embodiments, a method implemented by a network node in a communication network comprises: triggering one or more aperiodic channel state information (A-CSI) reports from a user equipment (UE) through downlink control information (DCI); and providing to the UE information about a physical uplink control channel (PUCCH) resource for transmitting the triggered one or more A-CSI reports.

### TECHNICAL FIELD

The present disclosure generally relates to the field of wireless communications, and more specifically to providing physical uplink control channel (PUCCH) resources for triggered aperiodic channel state information (A-CSI).

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

This section introduces aspects that may facilitate better understanding of the present disclosure. Accordingly, the statements of this section are to be read in this light and are not to be understood as admissions about what is in the prior art or what is not in the prior art.

Third Generation Partnership Project (3GPP) wireless specifications include fifth generation (5G) new radio (NR). NR uses cyclic prefix orthogonal frequency division multiplexing (CP-OFDM) in both downlink (DL) (i.e., from a network node, gNB or base station to a user equipment or UE) and uplink (UL) (i.e., from UE to gNB). Discrete Fourier transform (DFT) spread OFDM is also supported in the uplink. In the time domain, NR downlink and uplink are organized into equally sized subframes of 1 ms each. A subframe is further divided into multiple slots of equal duration. The slot length depends on subcarrier spacing. For subcarrier spacing of Δf=15 kHz, there is only one slot per subframe, and each slot consists of 14 OFDM symbols.

Data scheduling in NR is typically on a slot basis, an example of which is shown in FIG. 1 with a 14-symbol slot, where the first two symbols contain physical downlink control channel (PDCCH) and the rest contains physical shared data channel, either PDSCH (physical downlink shared channel) or PUSCH (physical uplink shared channel).

Different subcarrier spacing values are supported in NR. The supported subcarrier spacing values (also referred to as different numerologies) are given by Δf=(15×2^{μ}) kHz where μ∈{0,1,2,3,4}. Δf=15 kHz is the basic subcarrier spacing. The slot durations at different subcarrier spacings are given by ½^{μ} ms.

In the frequency domain, a system bandwidth is divided into resource blocks (RBs), each of which corresponds to 12 contiguous subcarriers. The RBs are numbered starting with 0 from one end of the system bandwidth. A basic NR physical time-frequency resource grid is illustrated in FIG. 2, where only one resource block (RB) within a 14-symbol slot is shown. One OFDM subcarrier during one OFDM symbol interval forms one resource element (RE).

Downlink and uplink data transmissions can be either dynamically or semi-persistently scheduled by a gNB. In the case of dynamic scheduling, the gNB may transmit, in a downlink slot, downlink control information (DCI) to a UE on physical downlink control channel (PDCCH) about data carried on PDSCH to the UE and/or data on PUSCH to be transmitted by the UE. In the case of semi-persistent scheduling, periodic data transmission in certain slots can be configured and activated/deactivated.

For each transport block data transmitted over PDSCH, a hybrid automatic repeat request acknowledgement (HARQ-ACK) is sent in a UL PUCCH depending on whether it is successfully decoded or not. An ACK is sent if it is successfully decoded and a NACK is sent otherwise.

PUCCH can also carry other UL control information (UCI) such as scheduling request (SR) and DL channel state information (CSI).

There are three DCI formats defined for scheduling PDSCH in NR, i.e., DCI format 1_0 and DCI format 1_1 which were introduced in NR Rel-15, and DCI format 1_2 which was introduced in NR Rel-16. DCI format 1_0 has a smaller size than DCI 1_1 and can be used when a UE is not fully connected to the network while DCI format 1_1 can be used for scheduling MIMO (Multiple-Input-Multiple-Output) transmissions with multiple MIMO layers.

In NR Rel-16, DCI format 1_2 was introduced for downlink scheduling. One of main motivations for having the new DCI format is to be able to configure a very small DCI size which can provide some reliability improvement without losing much flexibility. A main design target of the new DCI format is thus to have DCI with configurable sizes for some fields with a minimum DCI size targeting a reduction of 10-16 bits relative to Rel-15 DCI format 1-0.

When receiving PDSCH in the downlink from a serving gNB at slot n, a UE feeds back a HARQ ACK at slot n+k over a PUCCH resource in the uplink to the gNB if the PDSCH is successfully decoded, or otherwise, the UE sends a HARQ ACK/NACK at slot n+k to the gNB to indicate that the PDSCH is not successfully decoded. If two transport blocks (TBs) are carried by the PDSCH, then a HARQ ACK/NACK is reported for each TB.

For DCI format 1_0, k is indicated by a 3-bit PDSCH-to-HARQ-timing-indicator field. For DCI formats 1_1 and 1_2, k is indicated either by a 0-3 bit PDSCH-to-HARQ-timing-indicator field, if present, or by higher layer configuration through radio resource control (RRC) signaling. Separate RRC configuration of PDSCH to HARQ-ACK timing is used for DCI formats 1_1 and 1_2.

For DCI format 1_1, if code block group (CBG) transmission is configured, a HARQ ACK/NACK for each CBG in a TB is reported instead.

For carrier aggregation (CA) with multiple carriers and/or TDD operation, multiple aggregated HARQ ACK/NACK bits need to be sent in a single PUCCH.

In NR, up to four PUCCH resource sets can be configured to a UE. A PUCCH resource set with pucch-ResourceSetId=0 can have up to 32 PUCCH resources while for PUCCH resource sets with pucch-ResourceSetId=1 to 3, each set can have up to 8 PUCCH resources. A UE determines the PUCCH resource set in a slot based on the number of aggregated uplink control information (UCI) bits to be sent in the slot. The UCI bits consist of HARQ ACK/NACK, scheduling request (SR), and channel state information (CSI) bits.

A 3-bit PUCCH resource indicator (PRI) field in DCI maps to a PUCCH resource in a set of PUCCH resources with a maximum of eight PUCCH resources. For the first set of PUCCH resources with pucch-ResourceSetId=0 and when the number of PUCCH resources, R_{PUCCH}, in the set is larger than eight, the UE determines a PUCCH resource with index r_{PUCCH}, 0≤r_{PUCCH}≤R_{PUCCH}−1, for carrying HARQ-ACK information in response to detecting a last DCI format 1_0 or DCI format 1_1 in a PDCCH reception, among DCI formats 1_0 or DCI formats 1_1 the UE received with a value of the PDSCH-to-HARQ_feedback timing indicator field indicating a same slot for the PUCCH transmission, as

$${r}_{PUCCH} = \{ \begin{matrix}⌊ \frac{{n}_{CCE , p} \cdot ⌈ {R}_{PUCCH} / 8 ⌉}{{N}_{CCE , p}} ⌋ + {Δ}_{PRI} \cdot ⌈ \frac{{R}_{PUCCH}}{8} ⌉ & if {Δ}_{PRI} < {R}_{PUCCH} mod 8 \\ \begin{matrix}⌊ \frac{{n}_{CCE , p} \cdot ⌊ {R}_{PUCCH} / 8 ⌋}{{N}_{CCE , p}} ⌋ + {Δ}_{PRI} \cdot ⌊ \frac{{R}_{PUCCH}}{8} ⌋ + \\ {R}_{PUCCH} mod 8\end{matrix} & if {Δ}_{PRI} \geq {R}_{PUCCH} mod 8\end{matrix} \}$$

where N_{CCE,p} is the number of CCEs in CORESET p of the PDCCH reception for the DCI format 1_0 or DCI format 1_1, n_{CCE,p} is the index of a first CCE for the PDCCH reception, and Δ_{PRI} is a value of the PUCCH resource indicator field in the DCI format 1_0 or DCI format 1_1.

For UEs in random access procedures, Msg4 PDSCH transmission or MsgB PDSCH transmission will be followed by an ACK transmission on PUCCH if the PDSCH is correctly decoded, where the PUCCH resource is determined in the following ways depending on whether a 4-step random access channel (RACH) and/or a 2-step RACH is selected.

During the 4-step random access procedure, in response to the PDSCH reception with the UE contention resolution identity, the UE transmits HARQ-ACK information in a PUCCH. The PUCCH transmission is within the same active UL bandwidth part (BWP) as the PUSCH transmission scheduled by a random access response (RAR) UL grant. The PUCCH resource and the slot are determined by a 3-bit “PUCCH resource indicator” field and a 3-bit “PDSCH-to-HARQ_feedback timing indicator” field respectively provided in DCI 1_0 with CRC scrambled by TC-RNTI.

A minimum time between the last symbol of the PDSCH reception and the first symbol of the corresponding PUCCH transmission with the HARQ-ACK information is equal to N_{T,1}+0.5 msec. N_{T,1} is a time duration of N₁ symbols corresponding to a PDSCH processing time for UE processing capability 1 when additional PDSCH DM-RS is configured. For μ=0 the UE assumes N_{1,0}=14.

During the 2-step random access procedure, the UE will trigger a transmission of a PUCCH with HARQ-ACK information having an ACK value if the RAR message(s) (MsgB) is for successRAR, where a PUCCH resource for the transmission of the PUCCH is indicated by a PUCCH resource indicator field of 4 bits in the successRAR from a PUCCH resource set that is provided by pucch-ResourceCommon, and a slot for the PUCCH transmission is indicated by a HARQ Feedback Timing Indicator field of 3 bits in the successRAR having a value k from {1, 2, 3, 4, 5, 6, 7, 8} and, with reference to slots for PUCCH transmission having duration T_slot, the slot is determined as n+k+Δ, where n is a slot of the PDSCH reception and Δ is as defined for PUSCH transmission in Table 6.1.2.1.1-5 in 3GPP TS 38.214 V16.2.0.

The UE does not expect the first symbol of the PUCCH transmission to be after the last symbol of the PDSCH reception by a time smaller than N_(T,1)+0.5 msec where N_(T,1) is the PDSCH processing time for UE processing capability 1.

The successRAR is an octet aligned and is of fixed size as depicted in FIG. 3.

As shown in Table 1 below, five PUCCH formats are defined in NR, i.e., PUCCH formats 0 to 4. The UE transmits UCI in a PUCCH using PUCCH format 0 if the transmission is over 1 symbol or 2 symbols and the number of HARQ-ACK information bits with positive or negative SR (HARQ-ACK/SR bits) is 1 or 2. The UE transmits UCI in a PUCCH using PUCCH format 1 if the transmission is over 4 or more symbols and the number of HARQ-ACK/SR bits is 1 or 2. The UE transmits UCI in a PUCCH using PUCCH format 2 if the transmission is over 1 symbol or 2 symbols and the number of UCI bits is more than 2. The UE transmits UCI in a PUCCH using PUCCH format 3 if the transmission is over 4 or more symbols and the number of UCI bits is more than 2. The UE transmits UCI in a PUCCH using PUCCH format 4 if the transmission is over 4 or more symbols and the number of UCI bits is more than 2.

PUCCH formats 0 and 2 use one or two OFDM symbols while PUCCH formats 1, 3 and 4 can span from 4 to 14 symbols. Thus, PUCCH formats 0 and 2 are referred to as short PUCCH while PUCCH formats 1, 3 and 4 are referred to as long PUCCH.

TABLE 1

| | Length in OFDM symbols | |
|---|---|---|
| PUCCH format | N_{symb}^{PUCCH} | Number of bits |
| 0 | 1-2 | ≤2 |
| 1 | 4-14 | ≤2 |
| 2 | 1-2 | >2 |
| 3 | 4-14 | >2 |
| 4 | 4-14 | >2 |

FIG. 4 illustrates an example of one and two symbol short PUCCH without FH, where FIG. 4(a) illustrates one symbol PUCCH and FIG. 4(b) illustrates two symbol PUCCH.

A PUCCH format 0 resource can be one or two OFDM symbols within a slot in time domain and one RB in frequency domain. UCI is used to select a cyclic shift of a computer-generated length 12 base sequence which is mapped to the RB. The starting symbol and the starting RB are configured by RRC. When 2 symbols are configured, the UCI bits are repeated in 2 consecutive symbols.

A PUCCH format 2 resource can be one or two OFDM symbols within a slot in time domain and one or more RB in frequency domain. UCI in PUCCH Format 2 is encoded with RM (Reed-Muller) codes (≤11 bit UCI+CRC) or Polar codes (>11 bit UCI+CRC) and scrambled. When 2 symbols are configured, UCI is encoded and mapped across two consecutive symbols.

Intra-slot frequency hopping (FH) may be enabled when 2 symbols are configured for PUCCH formats 0 and 2. If FH is enabled, the starting PRB in the second symbol is configured by RRC. Cyclic shift hopping is used when 2 symbols are configured such that different cyclic shifts are used in the 2 symbols.

FIG. 5 illustrates an example 14-symbol and 7-symbol long PUCCH with intra-slot FH enabled, wherein FIG. 5(a) illustrates 14 symbol PUCCH and FIG. 5(b) illustrates 7 symbol PUCCH.

FIG. 6 illustrates an example 14-symbol and 7-symbol long PUCCH with intra-slot FH disabled, wherein FIG. 6(a) illustrates 14 symbol PUCCH and FIG. 6(b) illustrates 7 symbol PUCCH.

A PUCCH format 1 resource is 4-14 symbols long and 1 PRB wide per hop. A computer-generated length 12 base sequence is modulated with UCI and weighted with time-domain OCC code. Frequency-hopping with one hop within the active UL BWP for the UE is supported and can be enabled/disabled by RRC. Base sequence hopping across hops is enabled for FH and across slots when no FH.

A PUCCH Format 3 resource is 4-14 symbols long and one or multiple PRB wide per hop. UCI in PUCCH Format 3 is encoded with RM (Reed-Muller) codes (≤11 bit UCI+CRC) or Polar codes (>11 bit UCI+CRC) and scrambled.

A PUCCH Format 4 resource is also 4-14 symbols long but 1 PRB wide per hop. It has a similar structure as PUCCH format 3 but can be used for multi-UE multiplexing.

For PUCCH formats 1, 3 or 4, a UE can be configured with a number of slots, N_{PUCCH}^{repeat}, for repetitions of a PUCCH transmission by respective nrofSlots which is defined in following IE:

| | |
|---|---|
| PUCCH-FormatConfig ::= | SEQUENCE { |
| interslotFrequencyHopping | ENUMERATED {enabled} |

OPTIONAL, -- Need R

| | |
|---|---|
| additionalDMRS | ENUMERATED {true} |

OPTIONAL, -- Need R

| | |
|---|---|
| maxCodeRate | PUCCH-MaxCodeRate |

OPTIONAL, -- Need R

| | |
|---|---|
| nrofSlots | ENUMERATED {n2, n4, n8} |

OPTIONAL, -- Need S

| | |
|---|---|
| pi2BPSK | ENUMERATED {enabled} |

OPTIONAL, -- Need R

| | |
|---|---|
| simultaneousHARQ-ACK-CSI | ENUMERATED {true} |

OPTIONAL -- Need R
}

The nrofSlots is the number of slots with the same PUCCH F1, F3 or F4. When the field is absent, the UE applies the value n1. The field is not applicable for format 2.

For N_{PUCCH}^{repeat}>1, the UE repeats the PUCCH transmission with the UCI over N_{PUCCH}^{repeat} slots, a PUCCH transmission in each of the N_{PUCCH}^{repeat} slots has a same number of consecutive symbols, and a PUCCH transmission in each of the N_{PUCCH}^{repeat} slots has a same first symbol.

If the UE is configured to perform frequency hopping for PUCCH transmissions across different slots, then the UE performs frequency hopping per slot and the UE transmits the PUCCH starting from a first PRB in slots with even number and starting from the second PRB in slots with odd number. The slot indicated to the UE for the first PUCCH transmission has number 0 and each subsequent slot until the UE transmits the PUCCH in N_{PUCCH}^{repeat} slots is counted regardless of whether or not the UE transmits the PUCCH in the slot. The UE does not expect to be configured to perform frequency hopping for a PUCCH transmission within a slot

If the UE is not configured to perform frequency hopping for PUCCH transmissions across different slots and if the UE is configured to perform frequency hopping for PUCCH transmissions within a slot, the frequency hopping pattern between the first PRB and the second PRB is same within each slot.

FIG. 7 illustrates an example of PUCCH repetition in two slots, wherein FIG. 7(a) illustrates inter-slot FH enabled and FIG. 7(b) illustrates inter-slot FH disabled and intra-slot FH enabled.

The PUCCH resources used can be configured for the UE. In Rel-15, a UE can be configured with maximum four PUCCH resource sets where each PUCCH resource set consists of a number of PUCCH resources that can be used for a range of UCI sizes provided by configuration, including HARQ-ACK bits. The first set is only applicable for 1-2 UCI bits including HARQ-ACK information and can have maximum 32 PUCCH resources, while the other sets, if configured, are used for more than 2 UCI bits including HARQ-ACK and can have maximum 8 PUCCH resources.

| PUCCH-ResourceSet ::= | SEQUENCE { |
|---|---|
| pucch-ResourceSetId | PUCCH-ResourceSetId, |
| resourceList | SEQUENCE (SIZE |
| (1..maxNrofPUCCH-Resources PerSet)) OF PUCCH-ResourceId, | |
| maxPayloadSize | INTEGER (4..256) |
| OPTIONAL -- Need R | |
| } | |
| PUCCH-ResourceSetId ::= INTEGER (0..maxNrofPUCCH-ResourceSets-1) | |
| maxNrofPUCCH-ResourceSets | INTEGER ::= 4 -- Maximum |

number of PUCCH Resource Sets

If a UE does not have dedicated PUCCH resource configuration provided by PUCCH-ResourceSet in PUCCH-Config, a PUCCH resource set is provided by pucch-ResourceCommon through an index to a row of Table 9.2.1-1 in 38.213 V16.2.0 for transmission of HARQ-ACK information on PUCCH in an initial UL BWP of N_{BWP}^{size} PRBs.

The PUCCH resource set includes sixteen resources, each corresponding to a PUCCH format, a first symbol, a duration, a PRB offset RB_{BWP}^{offset}, and a cyclic shift index set for a PUCCH transmission.

-- ASN1START
-- TAG-PUCCH-CONFIGCOMMON-START

| | |
|---|---|
| PUCCH-ConfigCommon ::= | SEQUENCE { |
| pucch-ResourceCommon | INTEGER (0..15) |

OPTIONAL, -- Cond InitialBWP-Only

| | |
|---|---|
| pucch-GroupHopping | ENUMERATED { neither, enable, |

disable },

| | |
|---|---|
| hoppingId | INTEGER (0..1023) |

OPTIONAL, -- Need R

| | |
|---|---|
| p0-nominal | INTEGER (−202..24) |

OPTIONAL, -- Need R
...
}
-- TAG-PUCCH-CONFIGCOMMON-STOP
-- ASN1STOP

The pucch-ResourceCommon parameter is an entry into a 16-row table where each row configures a set of cell-specific PUCCH resources/parameters. The UE uses those PUCCH resources until it is provided with a dedicated PUCCH-Config (e.g. during initial access) on the initial uplink BWP. Once the network provides a dedicated PUCCH-Config for that bandwidth part the UE applies that one instead of the one provided in this field.

NR Rel-16 introduces sub-slot based PUCCH transmission so that HARQ-ACK associated with different type of traffic can be multiplexed in a same UL slot, each transmitted in a different sub-slot. The sub-slot size can be higher layer configured to either 2 symbols or 7 symbols. For sub-slot configuration each with 2 symbols, there are 7 sub-slots in a slot. For sub-slot with 7 symbols, there are two sub-slots in a slot.

NR Rel-16 also includes HARQ ACK/NACK enhancement for URLLC. In NR Rel 16, a higher priority may be assigned to PDSCHs carrying URLLC (ultra-reliable low-latency) traffic and indicated in DCIs scheduling the PDSCHs. HARQ ACK/NACK information for PDSCHs with higher priority is transmitted separately from HARQ ACK/NACK information for other PDSCHs. This enables HARQ ACK/NACK for URLLC traffic to be transmitted early in different PUCCH resources and more reliably.

Furthermore, for NR Rel-16 at least one sub-slot configuration for PUCCH can be UE-specifically configured and multiple HARQ ACK/NACK transmissions per slot are possible. The sub-slot configuration supports periodicities of 2 symbols (i.e., seven 2-symbol PUCCH occasions per slot) and 7 symbols (i.e., two 7-symbol PUCCH occasions per slot). One of the reasons for introducing these sub-slot configurations in NR Rel-16 is to enable the possibility for multiple opportunities of HARQ ACK/NACK transmissions within a slot without needing to configure several PUCCH resources.

For example, in Rel-16, a UE running URLLC service may be configured with a possibility of receiving PDCCH in every second OFDM symbol, e.g., symbol 0, 2, 4, . . . , 12 and be configured with a PUCCH resource with sub-slot configuration seven 2-symbol sub-slots within a slot for HARQ-ACK transmission also in every second symbol, e.g. 1, 3, . . . , 13. For a Rel-16 UE configured with sub-slots for PUCCH transmission, the PDSCH-to-HARQ feedback timing indicator field in DCI indicates the timing offset in terms of sub-slots instead of slots.

NR also includes a CSI framework. In NR, a UE can be configured with multiple CSI reporting settings (each represented by a higher layer parameter CSI-ReportConfig with an associated identity ReportConfigID) and multiple CSI resource settings (each represented by a higher layer parameter CSI-ResourceConfig with an associated identity CSI-ResourceConfigId). Each CSI resource setting can contain multiple CSI resource sets (each represented by a higher layer parameter NZP-CSI-RS-ResourceSet with an associated identity NZP-CSI-RS-ResourceSetId for channel measurement or by a higher layer parameter CSI-IM-ResourceSet with an associated identity CSI-IM-ResourceSetId for interference measurement), and each NZP CSI-RS resource set for channel measurement can contain up to 8 NZP CSI-RS resources. For each CSI reporting setting, a UE feeds back a set of CSIs that may include one or more of a CRI (CSI-RS resource indicator), a RI, a PMI and a CQI per CW, depending on the configured report quantity.

Each Reporting Setting CSI-ReportConfig is associated with a single downlink BWP (indicated by higher layer parameter BWP-Id) given in the associated CSI-ResourceConfig for channel measurement and contains the parameter(s) for one CSI reporting band.

Each CSI reporting setting contains at least the following information:
A CSI resource setting for channel measurement based on NZP CSI-RS resources (represented by a higher layer parameter resourcesForChannelMeasurement)
A CSI resource setting for interference measurement based on CSI-IM resources (represented by a higher layer parameter csi-IM-ResourcesForinterference)
Optionally, a CSI resource setting for interference measurement based on NZP CSI-RS resources (represented by a higher layer parameter nzp-CSI-RS-ResourcesForInterference)
Time-domain behavior, i.e. periodic, semi-persistent, or aperiodic reporting (represented by a higher layer parameter reportConfigType)
Frequency granularity, i.e. wideband or subband
CSI parameters to be reported such as RI, PMI, CQI, L1-RSRP/L1_SINR and CRI in the case that multiple NZP CSI-RS resources in a resource set is used for channel measurement (represented by a higher layer parameter report Quantity, such as ‘cri-RI-PMI-CQI’ ‘cri-RSRP’, or ‘ssb-Index-RSRP’)
Codebook types, i.e. type I or II if reported, and codebook subset restriction
Measurement restriction.

For periodic and semi-static CSI reporting, only one NZP CSI-RS resource set can be configured for channel measurement and one CSI-IM resource set for interference measurement.

For aperiodic CSI reporting, a CSI resource setting for channel measurement can contain more than one NZP CSI-RS resource set for channel measurement. If the CSI resource setting for channel measurement contains multiple NZP CSI-RS resource sets for aperiodic CSI report, only one NZP CSI-RS resource set can be selected and indicated to a UE.

For aperiodic CSI reporting, a list of trigger states is configured (given by the higher layer parameters CSI-AperiodicTriggerStateList). Each trigger state in CSI-AperiodicTriggerStateList contains a list of associated CSI-ReportConfigs indicating the Resource Set IDs for channel and optionally for interference. For a UE configured with the higher layer parameter CSI-AperiodicTriggerStateList, if a Resource Setting linked to a CSI-ReportConfig has multiple aperiodic resource sets, only one of the aperiodic CSI-RS resource sets from the Resource Setting is associated with the trigger state, and the UE is higher layer configured per trigger state per Resource Setting to select the one NZP CSI-RS resource set from the Resource Setting.

When more than one NZP CSI-RS resources are contained in the selected NZP CSI-RS resource set for channel measurement, a CSI-RS resource indicator (CRI) is reported by the UE to indicate to the gNB about the one selected NZP CSI-RS resource in the resource set, together with RI, PMI and CQI associated with the selected NZP CSI-RS resource. This type of CSI assumes that a PDSCH is transmitted from a single transmission point (TRP) and the CSI is also referred to as single TRP CSI.

In NR releases 15 and 16, an aperiodic measurement is triggered within DCI to indicate which Report Setting(s) and CSI-RS resource(s) for which to report CSI. In DCI format 0-1 and 0-2, a “CSI request” field is included for this purpose.

For DCI 0-1, the CSI request is 0, 1, 2, 3, 4, 5, or 6 bits determined by higher layer parameter reportTriggerSize. For DCI 0-2, the CSI request is 0, 1, 2, 3, 4, 5, or 6 bits determined by higher layer parameter reportTriggerSizeForDCI-Format0-2.

In CSI-MeasConfig IE, 2 parameters are defined to determine the number of bits for “CSI request” in DCI format 0-1 and DCI format 0-2 respectively: reportTriggerSize, and reportTriggerSizeForDCI-Format0-2.

With respect to the size of CSI request field in DCI (bits), the field reportTriggerSize applies to DCI format 0_1 and the field reportTriggerSizeForDCI-Format0-2 applies to DCI format 0_2.

Another parameter aperiodicTriggerStateList below in the CSI-MeasConfig IE is used to configure the UE with a list of aperiodic trigger states. Each codepoint of the DCI field “CSI request” is associated with one trigger state (which describes the MAC CE used for Aperiodic CSI Trigger State Subselection). Upon reception of the value associated with a trigger state, the UE will perform measurement of CSI-RS, CSI-IM and/or SSB (reference signals) and aperiodic reporting on L1 according to all entries in the associatedReportConfigInfoList for that trigger state.

The aperiodicTriggerStateList contains trigger states for dynamically selecting one or more aperiodic and semi-persistent reporting configurations and/or triggering one or more aperiodic CSI-RS resource sets for channel and/or interference measurement.

-- TAG-CSI-APERIODICTRIGGERSTATELIST-START

| | |
|---|---|
| CSI-AperiodicTriggerStateList ::= | SEQUENCE (SIZE (1..maxNrOfCSI- |

AperiodicTriggers)) OF CSI-AperiodicTriggerState

| | |
|---|---|
| CSI-AperiodicTriggerState ::= | SEQUENCE { |
| associatedReportConfigInfoList | SEQUENCE |

(SIZE (1..maxNrofReportConfigPerAperiodicTrigger)) OF CSI-
AssociatedReportConfigInfo,
...
}

| | |
|---|---|
| CSI-AssociatedReportConfigInfo ::= | SEQUENCE { |
| reportConfigId | CSI-ReportConfigId, |
| resourcesForChannel | CHOICE { |
| nzp-CSI-RS | SEQUENCE { |
| resourceSet | INTEGER (1..maxNrofNZP-CSI- |

RS-ResourceSetsPerConfig),

| | |
|---|---|
| qcl-info | SEQUENCE |

(SIZE (1..maxNrofAP-CSI-RS-Resources PerSet)) OF TCI-StateId
OPTIONAL -- Cond Aperiodic
},

| | |
|---|---|
| csi-SSB-ResourceSet | INTEGER (1..maxNrofCSI-SSB- |

ResourceSetsPerConfig)
} ,

| | |
|---|---|
| csi-IM-Resources ForInterference | INTEGER (1..maxNrofCSI-IM- |

ResourceSetsPerConfig)
OPTIONAL, -- Cond CSI-IM-ForInterference

| | |
|---|---|
| nzp-CSI-RS-Resources ForInterference | INTEGER (1..maxNrofNZP-CSI-RS- |

ResourceSetsPerConfig)
OPTIONAL, -- Cond NZP-CSI-RS-ForInterference
. . .
}
-- TAG-CSI-APERIODICTRIGGERSTATELIST-STOP
-- ASN1STOP

There currently exist certain challenges. For example, in current NR specifications, aperiodic CSI feedback can only be carried via PUSCH. Furthermore, in current NR specifications, the aperiodic CSI feedback can only be trigged via uplink related DCI (i.e., DCI formats 0_1 and 0_2). However, this is not flexible in a scenario that is downlink heavy where the gNB would schedule the UE with PDSCH via downlink related DCI (i.e., DCI formats 1_1 and 1_2) more often than scheduling the UE with PUSCH via uplink related DCI. To improve network scheduling flexibility, it is beneficial to support triggering of aperiodic CSI via downlink related DCI. In this case, the aperiodic CSI will be carried on PUCCH.

That is, In NR, the existing specification only supports triggered A-CSI report on PUSCH, using uplink transmission related DCI formats, e.g., DCI format 0_1 and 0_2 or RAR. However, it is not clear how to provide PUCCH resource configuration for carrying A-CSI, if NR is enhanced to support A-CSI report on PUCCH, triggered by downlink transmission related DCI formats, e.g., DCI format 1_1 and 1_2, or by downlink shared channel.

Default PUCCH resource sets will be used when the dedicated PUCCH resource sets are not available, and when A-CSI is scheduled in the same DCI or PDSCH as HARQ feedback, additional schemes are needed to select a different PUCCH resource and/or PUCCH resource set if the A-CSI and the HARQ-ACK are not expected to be multiplexed on the same PUCCH, especially when only short PUCCH format is selected.

### SUMMARY

As described above, certain challenges currently exist with reporting aperiodic channel state information (A-CSI) on a physical uplink control channel (PUCCH). Certain aspects of the present disclosure and their embodiments may provide solutions to these or other challenges. For example, particular embodiments facilitate reporting A-CSI on a PUCCH by PUCCH resource and resource set determination for A-CSI report, PUCCH repetition support for reliable A-CSI report transmission, and common PUCCH resource and PUCCH resource set configuration before a dedicated PUCCH resource is available.

According to some embodiments, a method implemented by a network node in a communication network is provided. The method comprises: triggering A-CSI through downlink control information (DCI); and providing PUCCH resources for transmitting the triggered A-CSI.

In particular embodiments, the DCI may include downlink (DL) related downlink control information (DCI).

In particular embodiments, the PUCCH resources may be provided independently of channel state information (CSI) report configurations. In particular embodiments, the PUCCH resources may be provided as part of CSI report configurations.

Some embodiments include a network node in a communication network. The network node comprises a processor and a memory communicatively coupled to the processor and adapted to store instructions. When the instructions are executed by the processor, the instructions cause the network node to perform operations of the method according to the network node embodiments above.

Some embodiments include a non-transitory computer readable medium having a computer program stored thereon. When the computer program is executed by a set of one or more processors of a network node in a communication network, the computer program causes the network node to perform operations of the method according to the network node embodiments above.

According to some embodiments, a method implemented by a user equipment in a communication network comprises: receiving a triggering signal from a network node; receiving PUCCH resources from the network node; and transmitting triggered A-CSI to the network node over the received PUCCH resources.

Some embodiments include a user equipment in a communication network. The user equipment comprises a processor and a memory communicatively coupled to the processor and adapted to store instructions. When the instructions are executed by the processor, the instructions cause the user equipment to perform operations of the method according to the user equipment embodiments above.

Some embodiments include a non-transitory computer readable medium having a computer program stored thereon. When the computer program is executed by a set of one or more processors of a user equipment in a communication network, the computer program causes the user equipment to perform operations of the method according to the user equipment embodiments above.

In particular embodiments, A-CSI may be transmitted on PUCCH without depending on an uplink (UL) grant for data if only transmission of A-CSI on physical uplink shared channel (PUSCH) is not expected. Repetition may be supported on PUCCH, which provides more robust A-CSI transmission.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 is a schematic diagram illustrating data scheduling in new radio (NR);

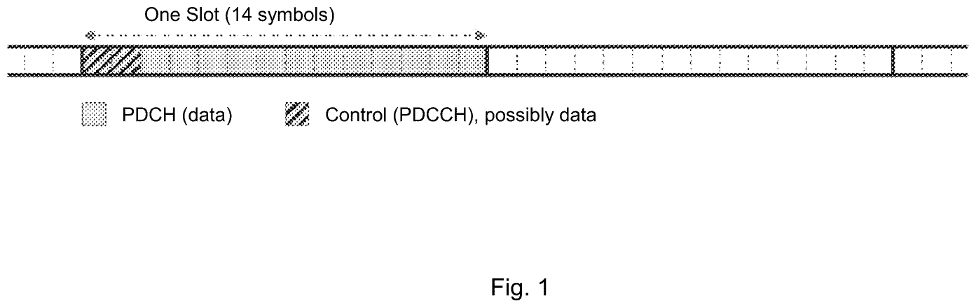

FIG. 2 is a schematic diagram illustrating a basic NR physical time-frequency resource grid;

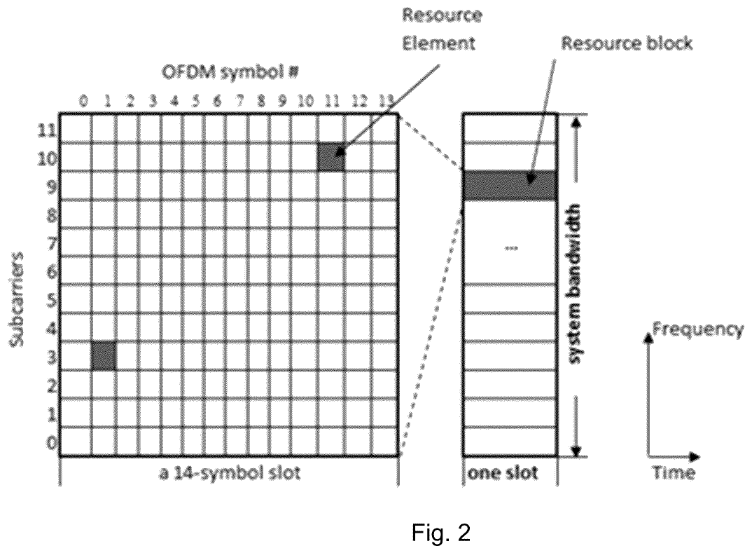

FIG. 3 is a schematic diagram illustrating an octet aligned and having fixed size;

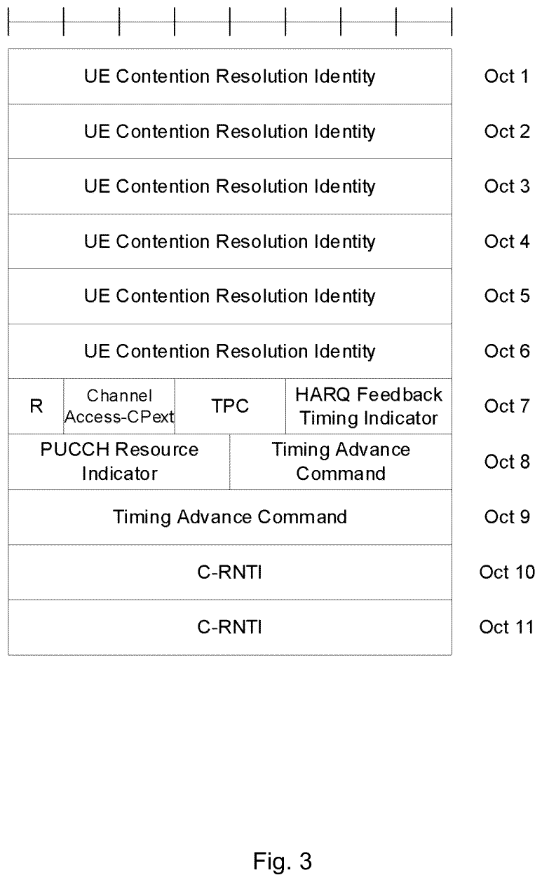

FIGS. 4(a) and 4(b) are graphs illustrating an example short PUCCH without frequency hopping (FH) in the cases with one symbol physical uplink control channel (PUCCH) and with two symbol PUCCH respectively;

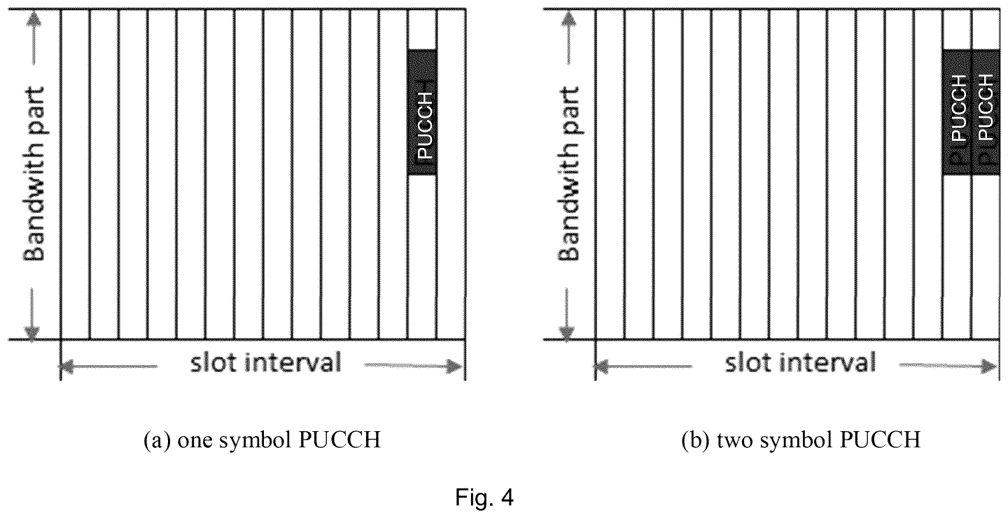

FIGS. 5(a) and 5(b) are graphs illustrating an example long PUCCH with intra-slot FH enabled in the cases with 14 symbol PUCCH and 7 symbol PUCCH respectively;

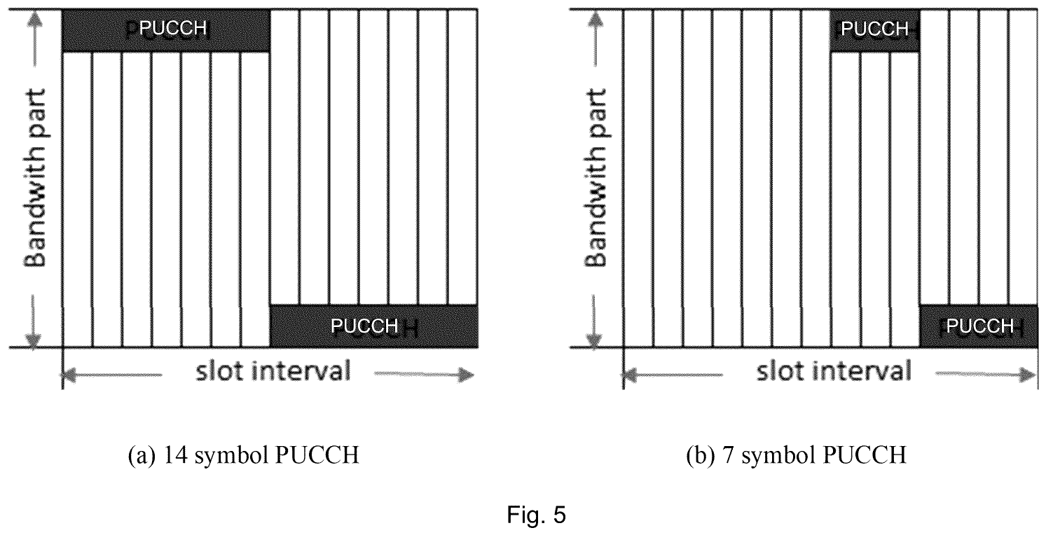

FIGS. 6(a) and 6(b) are graphs illustrating an example long PUCCH with intra-slot FH disabled in the cases with 14 symbol PUCCH and with 7 symbol PUCCH respectively;

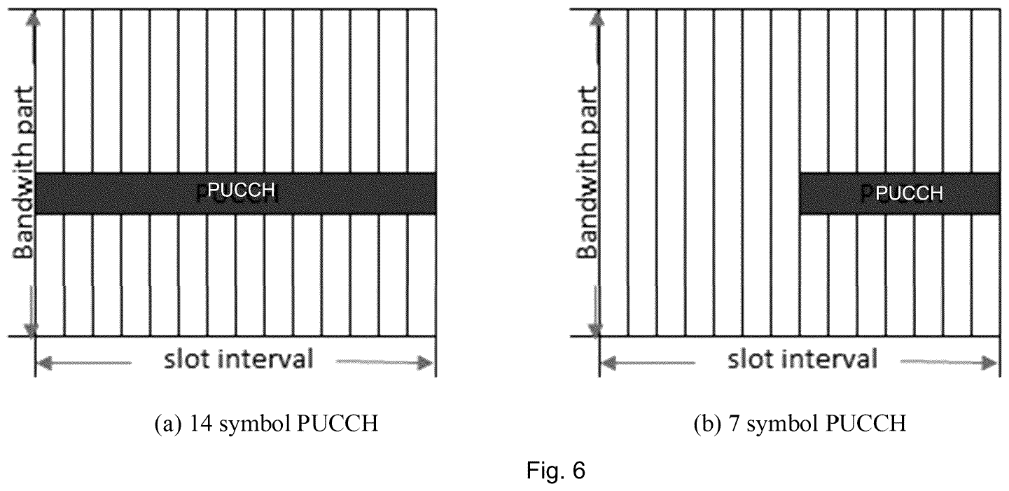

FIGS. 7(a) and 7(b) are graphs illustrating an example of PUCCH repetition in two slots in the cases with inter-slot FH enabled and with inter-slot FH disabled and intra-slot FH enabled respectively;

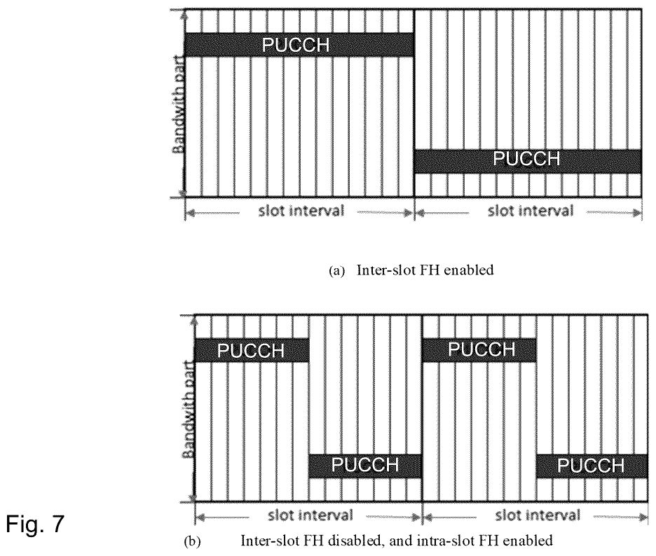

FIG. 8 is a schematic diagram illustrating an improved octet according to some embodiments;

FIG. 9 is a flow chart illustrating a method for providing PUCCH resources according to some embodiments;

FIG. 10 is a block diagram illustrating a network node for providing PUCCH resources according to some embodiments;

FIG. 11 is another block diagram illustrating a network node for providing PUCCH resources according to some embodiments;

FIG. 12 is a flow chart illustrating a method for transmitting triggered A-CSI over the PUCCH resources according to some embodiments;

FIG. 13 is a block diagram illustrating a user equipment for transmitting triggered A-CSI over the PUCCH resources according to some embodiments; and

FIG. 14 is another block diagram illustrating a user equipment for transmitting triggered A-CSI over the PUCCH resources according to some embodiments.

### DETAILED DESCRIPTION

As described above, certain challenges currently exist with reporting aperiodic channel state information (A-CSI) on a physical uplink control channel (PUCCH). Certain aspects of the present disclosure and their embodiments may provide solutions to these or other challenges.

In the following detailed description, numerous specific details such as logic implementations, types and interrelationships of system components, etc. are set forth to provide a more thorough understanding of particular embodiments. It should be appreciated by one skilled in the art that the particular embodiments may be practiced without such specific details. In other instances, control structures, circuits and instruction sequences have not been shown in detail to not obscure the present disclosure. Those of ordinary skill in the art, with the included descriptions, will be able to implement appropriate functionality without undue experimentation.

References in the specification to “one embodiment”, “an embodiment”, “an example embodiment” etc. indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed texts and blocks with dashed borders (e.g., large dashes, small dashes, dot-dash, and dots) may be used herein to illustrate optional operations that add additional features to embodiments of the present disclosure. However, such notation should not be taken to mean that these are the only options or optional operations, and/or that blocks with solid borders are not optional in certain embodiments of the present disclosure.

In the following detailed description and claims, the terms “coupled” and “connected”, along with their derivatives, may be used. It should be understood that these terms are not intended as synonyms for each other. “Coupled” is used to indicate that two or more elements, which may or may not be in direct physical or electrical contact with each other, cooperate or interact with each other. “Connected” is used to indicate the establishment of communication between two or more elements that are coupled with each other.

An electronic device stores and transmits (internally and/or with other electronic devices) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other forms of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For example, an electronic device may include non-volatile memory containing the code since the non-volatile memory can persist code/data even when the electronic device is turned off (when power is removed), and while the electronic device is turned on, that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical interfaces to establish connections (to transmit and/or receive code and/or data using propagating signals) with other electronic devices. One or more parts of an embodiment of the present disclosure may be implemented using different combinations of software, firmware, and/or hardware.

Particular embodiments are described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

The present disclosure provides methods and apparatuses for providing PUCCH resources for carrying triggered A-CSI. In general, the A-CSI may be triggered by various types of downlink control information (DCI) (also referred to as DL DCI), including DCIs that schedule physical uplink shared channel (PUSCH) (also referred to as UL DCI), DCIs that schedule physical downlink shared channel (PDSCH), group common DCI, etc. Other possible triggering mechanism may include media access control (MAC) control element (CE), or a field in a MAC CE. In the following, particular examples use DL DCI as an example to describe the methods for PUCCH resources, while it is clear to those skilled in the art that the same methodologies and principles may be used together with other triggering mechanisms.

In some embodiments, PUCCH resources are not provided by a channel state information (CSI) report configuration. When a DL DCI (i.e., with DCI format 1_x) is used to trigger A-CSI, the PUCCH resource for carrying the A-CSI may be needed. Here, the DCI format 1_x may refer to any DCI format that schedules PDSCH transmission, for example, DCI format 1_0, 1_1, 1_2. In contrast, UL DCI format 0_x may refer to any DCI format that schedules PUSCH transmission, for example, DCI format 0_0, 0_1, 0_2.

In this method, the PUCCH resources for dynamically triggered A-CSI are provided separately from the CSI report configuration. In a particular example, the PUCCH resources are provided via PUCCH configuration from higher layer, where the PUCCH configuration contains a list of PUCCH resource set.

Depending on a timing indication of HARQ-ACK response versus CSI report in the DL DCI, the triggered A-CSI may or may not be multiplexed with HARQ-ACK before mapping to the PUCCH resource.

In particular embodiments, the existing PUCCH resource configuration framework for UL DCI (i.e., DCI format 0_0, 0_1, 0_2) is reused, with one or more of the following modifications:

Currently, the PUCCH resources of format0 and format1 are only allowed in the first PUCCH resource set, i.e., in a PUCCH-ResourceSet with pucch-ResourceSetId=0. This means that the first resource set only supports uplink control information (UCI) payload size of 1 or 2 bits. Because CSI tends to have medium to high payload size (e.g., tens of bits or more), it is unnecessary to have the first PUCCH resource set to support payload <=2 bits. Thus, when configured for A-CSI transmission, all applicable PUCCH resource sets should support payload size >2 bits, using format2, format3 and format4.

For the UE to choose a PUCCH resource set based on the UCI size, a maximum size of payload more than 2 bits for the first PUCCH resource set should be supported. If the UE is configured with more than one PUCCH resource sets, a maximum size of UCI payload more than 2 bits for the first PUCCH resource set can be provided by higher layers.

Currently, the PUCCH resource indication field in the UL DCI (i.e., DCI format 0_2) has size of 3 bits. For indication of PUCCH resource for A-CSI, the PUCCH resource indication field in the DCI can be increased to M bits, M>3. For example, when setting M=4 bits, then up to 16 resources can be dynamically indicated.

In particular embodiments, any PUCCH resource set can be configured with a number of PUCCH resources that increase the maximum number to be indicated with the field in DCI for PUCCH resource (for example 8 PUCCH resources corresponding to 3-bits field in DCI as in Rel-15 and Re116). To indicate a PUCCH resource in a PUCCH resource set that is configured with resources more than for example 8, the implicit method based on control channel element (CCE) index as in Rel-15 may be reused. The combination of implicit indication of CCE index and explicit indication of the “PUCCH resource indicator” field in DCI then facilitates indication of up to 32 PUCCH resources.

In particular embodiments, the same PUCCH resource set configuration is used for providing PUCCH resource for HARQ-ACK as well as A-CSI. In this case, the higher layer parameters (PUCCH-ResourceSet, PUCCH-ResourceSet, etc.) can be reused, except that the specification may be modified such that the PUCCH resource sets can be used for UCI transmission triggered by DCI without HARQ-ACK.

In particular embodiments, a separate PUCCH resource set configuration is defined for A-CSI, i.e., one batch of configuration parameters for UCI transmission that includes HARQ-ACK, and another batch of configuration parameters for UCI transmission that does not include HARQ-ACK (e.g., for A-CSI). In this case, the batch of configuration for A-CSI does not need to include a PUCCH resource set for OUCI<=2 only, where OUCI refers to the number of UCI bits to be transmitted on PUCCH. Thus, all PUCCH resource sets are meaningful for CSI transmission. Additionally, the PUCCH resource may be better configured for CSI transmission, considering that CSI tends to have larger payload size than HARQ-ACK, but does not require as low error probability as that of HARQ-ACK. For example, the PUCCH resources and resource sets configured for A-CSI may use different values than those for HARQ-ACK in terms of parameters such as:
maxCodeRate: i.e., Max coding rate to determine how to feedback UCI on PUCCH for format 2, 3 or 4. For example, PUCCH resource for A-CSI can use a higher maxCodeRate than that for HARQ-ACK.
interslotFrequencyHopping: i.e., UE enables inter-slot frequency hopping when PUCCH Format 1, 3 or 4 is repeated over multiple slots. For example, PUCCH resource for A-CSI does not enable frequency hopping, while PUCCH resource for HARQ-ACK uses frequency hopping.
nrofSlots: i.e., number of slots with the same PUCCH F1, F3 or F4. For example, PUCCH resource for A-CSI occupies 2 slots, while PUCCH resource for HARQ-ACK occupies 4 slots.
nrofPRBs: i.e., number of PRBs occupied by the PUCCH. For example, PUCCH resource for A-CSI occupies 5 PRBs, while PUCCH resource for HARQ-ACK occupies 2 PRB.
maxPayloadSize: i.e., Maximum number of UCI information bits that the UE may transmit using this PUCCH resource set. For example, the first PUCCH resource set Set0 for A-CSI is configured with maxPayloadSize=16 bits, while first PUCCH resource set Set0 for HARQ-ACK does not contain the maxPayloadSize field and has a default value of 2 bits.

In particular embodiments, when A-CSI triggered by DL DCI is configured, then the maximum total number of PUCCH resource set (i.e., parameter maxNrofPUCCH-ResourceSets) increased from 4 to n, where n>4.

In particular embodiments, the same 3 bits PUCCH resource indicator (PRI) field in DL DCI is used for both HARQ-ACK and A-CSI regardless whether the A-CSI is multiplexed with HARQ-ACK associated with the same DCI. If the A-CSI is not multiplexed with HARQ-ACK, the same PRI is used to determine a PUCCH resource for the A-CSI in one of the PUCCH resource sets containing one of PUCCH formats 2, 3, and 4.

In particular embodiments, the PUCCH resource for A-CSI on PUCCH is provided by a list of PUCCH resources for A-CSI on PUCCH, e.g., multi-A-CSI-PUCCH-ResourceList, in PUCCH-Config. A PUCCH resource may be determined from the multi-A-CSI-PUCCH-ResourceList based on the number of A-CSI reports on PUCCH. In some examples with two or more PUCCH-Config, the multi-A-CSI-PUCCH-ResourceList can reside in any of the PUCCH-Config. In other examples, there is a multi-A-CSI-PUCCH-ResourceList in each one of the PUCCH-Config, where the multi-A-CSI-PUCCH-ResourceList residing in the PUCCH-Config associated with HARQ-ACK priority index A is valid for A-CSI on PUCCH of priority index A. In such examples, the priority index of A-CSI on PUCCH may be indicated by a priority index field in DL DCI triggering the A-CSI on PUCCH, or may be configured by RRC, e.g., by a field in CSI-ReportConfig or in trigger state for A-CSI on PUCCH (e.g., in CSI-AperiodicTriggerState).

In some embodiments, PUCCH resources are provided by CSI report configuration. For example, the PUCCH resources may be provided as part of CSI report configuration, where the PUCCH is used for carrying triggered A-CSI.

In one example, a separate PUCCH resource is specifically configured for A-CSI in the CSI-ReportConfig information element. An example of the modified CSI-ReportConfig information element is shown below. In the modified CSI-ReportConfig information element, a new CSI reporting configuration type (e.g., aperiodicOnPUCCH-r17) may be used to be reported on PUCCH. As shown in the example below, a PUCCH resource (e.g., ‘pucch-Resource’) with a resource identifier ‘PUCCH-ResourceId’ is configured as part of the new CSI reporting configuration type. In some embodiments, the PUCCH resource provided in the new CSI reporting configuration type can be periodic. If the PUCCH resource is periodic, then reportSlotConfig-r17, which provides the periodicity and slot offset of the PUCCH resource, may be configured as part of the new CSI reporting configuration type. A benefit of configuring the PUCCH resource separately for A-CSI triggered by DL related DCI is that the PUCCH resource can be better configured for CSI transmission.

CSI-ReportConfig information element

-- ASN1START
-- TAG-CSI-REPORTCONFIG-START

| | |
|---|---|
| CSI-ReportConfig ::= | SEQUENCE { |
| reportConfigId | CSI-ReportConfigId, |
| carrier | ServCellIndex |

OPTIONAL, -- Need S

| | |
|---|---|
| resourcesForChannelMeasurement | CSI-ResourceConfigId, |
| csi-IM-ResourcesForInterference | CSI-ResourceConfigId |

OPTIONAL -- Need R

| | |
|---|---|
| nzp-CSI-RS-ResourcesForInterference | CSI-ResourceConfigId |

OPTIONAL -- Need R

| | |
|---|---|
| reportConfigType | CHOICE { |
| periodic | SEQUENCE { |
| reportSlotConfig | CSI- |

ReportPeriodicityAndOffset,

| | |
|---|---|
| pucch-CSI-ResourceList | SEQUENCE (SIZE |

(1..maxNrofBWPs)) OF PUCCH-CSI-Resource
},

| | |
|---|---|
| semiPersistentOnPUCCH | SEQUENCE { |
| reportSlotConfig | CSI- |

ReportPeriodicityAndOffset,

| | |
|---|---|
| pucch-CSI-ResourceList | SEQUENCE (SIZE |

(1..maxNrofBWPs)) OF PUCCH-CSI-Resource
},

| | |
|---|---|
| semiPersistentOnPUSCH | SEQUENCE { |
| reportSlotConfig | ENUMERATED { sl5, sl10, |

sl20, sl40, sl80, sl160, sl320},

| | |
|---|---|
| reportSlotOffsetList | SEQUENCE (SIZE (1.. |

maxNrofUL-Allocations)) OF INTEGER (0..32),

| | |
|---|---|
| p0alpha | P0-PUSCH-AlphaSetId |

},

| | |
|---|---|
| aperiodic | SEQUENCE { |
| reportSlotOffsetList | SEQUENCE (SIZE |

```
(1..maxNrofUL-Allocations)) OF INTEGER (0..32)
      }
  },
  ...,
  [[
```

| | |
|---|---|
| reportConfigType-r17 | SEQUENCE { |
| aperiodicOnPUCCH-r17 | SEQUENCE { |
| pucch-Resource | PUCCH-ResourceId |
| reportSlotConfig-r17 | CSI- |

ReportPeriodicityAndOffset,
}

| | |
|---|---|
| } | OPTIONAL, - |

- Need R
]]
}
-- TAG-CSI-REPORTCONFIG-STOP
-- ASN1STOP

In another example, the RRC CSI report configuration provides a set of PUCCH resources (e.g., a list of 2n entries) for triggered A-CSI. Correspondingly, n bits in the DCI provide the index to the set of PUCCH resources. In the illustrated configuration below, 2n is provided by a parameter ‘maxNrofPUCCH-ACSI’.

Furthermore, the RRC CSI report configuration may provide a set of slot offsets for transmitting the PUCCH (e.g., a list of 2m entries) for triggered A-CSI. Correspondingly, m bits in the DCI provide the index to the set of slot offsets. In the illustrated configuration below, 2m is provided by a parameter ‘maxNrofPUCCH-Allocations’. In particular examples, the slot offset provides the slot for PUCCH transmission relative to the PDCCH slot timing, where the PDCCH contains the triggering DCI.

An example of the CSI report configuration is illustrated below.

| CSI-ReportConfig ::= | SEQUENCE { |
|---|---|
| reportConfigId | CSI-ReportConfigId, |
| ..., | |
| [[ | |
| reportConfigType-r17 | SEQUENCE { |
| aperiodicOnPUCCH-r17 | SEQUENCE { |
| pucch-ResourceList-r17 | SEQUENCE (SIZE |
| (1..maxNrofPUCCH-ACSI)) OF PUCCH-ResourceId, | |
| pucch-reportSlotOffsetList-r17 | SEQUENCE (SIZE |
| (1..maxNrofPUCCH-Allocations)) OF INTEGER (0..32), | |
| } | |
| } | OPTIONAL, - |

- Need R
]]
}

Some embodiments include repetition of aperiodic CSI triggered by DL DCI or DL PDSCH. In particular embodiments, the aperiodic CSI triggered by DL DCI may be configured to repeat across slots (or sub-slots). The number of repetitions may be provided via a new field in PUCCH resource, and in this case no DCI indication is necessary. In one example, up to 8 repetitions can be applied for one PUCCH resource.

| PUCCH-Resource ::= | SEQUENCE { |
|---|---|
| pucch-ResourceId | PUCCH-ResourceId, |
| startingPRB | PRB-Id, |
| intraSlotFrequencyHopping | ENUMERATED { enabled } |
| OPTIONAL, -- Need R | |
| secondHopPRB | PRB-Id |
| OPTIONAL, -- Need R | |
| format | CHOICE { |
| format0 | PUCCH-format0, |
| format1 | PUCCH-format1, |
| format2 | PUCCH-format2, |
| format3 | PUCCH-format3, |
| format4 | PUCCH-format4 |
| } | |
| NrofRepetition | INTEGER (1..8) |

}

In another example, candidates of number of repetitions may be a subset of values from [1, 8], e.g. {2, 4, 8}, which is similar to SP-CSI/P-CSI repetition on PUCCH in NR releases 15 and 16.

| PUCCH-Resource ::= | SEQUENCE { |
|---|---|
| pucch-ResourceId | PUCCH-ResourceId, |
| startingPRB | PRB-Id, |
| intraSlotFrequencyHopping | ENUMERATED { enabled } |
| OPTIONAL, -- Need R | |
| secondHopPRB | PRB-Id |
| OPTIONAL, -- Need R | |
| format | CHOICE { |
| format0 | PUCCH-format0, |
| format1 | PUCCH-format1, |
| format2 | PUCCH-format2, |
| format3 | PUCCH-format3, |
| format4 | PUCCH-format4 |
| } | |
| NrofRepetition | ENUMERATED {n2, n4, n8} |

}

In another example, the number of repetitions may be provided in the CSI reporting configurations such that different CSI report configurations may be configured with different number PUCCH repetitions, and these different CSI report configurations may be triggered by a field (for example, a ‘CSI Request’ field or equivalent DCI bits) in downlink DCI. One configuration example is illustrated below, assuming that the number of repetitions range from 1 to 8.

| | |
|---|---|
| CSI-ReportConfig ::= | SEQUENCE { |
| reportConfigId | CSI-ReportConfigId, |

```
  ...,
  [[
```

| | |
|---|---|
| reportConfigType-r17 | SEQUENCE { |
| aperiodicOnPUCCH-r17 | SEQUENCE { |
| pucch-ResourceList-r17 | SEQUENCE (SIZE |

(1..maxNrofPUCCH-ACSI)) OF PUCCH-ResourceId,

| | |
|---|---|
| pucch-reportSlotOffsetList-r17 | SEQUENCE (SIZE |

(1..maxNrofPUCCH-Allocations)) OF INTEGER (0..32),

| | |
|---|---|
| NrofRepetition | INTEGER (1..8) |

}

| | |
|---|---|
| } | OPTIONAL, - |

- Need R
]]
}

In particular embodiments, the allowed number of repetitions may be related to one or more of the following:
the PUCCH format; e.g. for short PUCCH formats, up to 7 repetitions may be defined, while for long PUCCH format up to 8 repetitions may be defined;
whether repetition is within a slot or across slot or both; e.g. when a PUCCH with less than 7 symbols, up to 16 repetitions may be allowed;
number of PRBs; e.g. with a larger number of PRBs, a smaller number of repetitions in time domain may be enough;
whether inter-slot and/or intra-slot frequency hopping is enabled or not; e.g. when frequency hopping is enabled, fewer number of repetitions in time domain might be enough given enough frequency diversity from hopping.

In particular embodiments, the number of repetitions semi-statically configured in PUCCH-Config IE (or CSI-ReportConfig IE) may be overwritten by the dynamically signaled number of repetitions provided in the triggering DCI (for example, a downlink DCI). In some embodiments, the number of repetitions can be provided via a new field in downlink DCI.

In particular embodiments, the aperiodic CSI is triggered by a payload in the PDSCH, for example, when a MAC CE is carried by the PDSCH. In general, the A-CSI may be configured to repeat across slots (or sub-slots). The number of repetitions may be provided via a new field in the payload of the PDSCH. This is illustrated in the example below of a MAC CE where the NrofRepetitionPUCCH defines the number of repetitions of PUCCH scheduled for A-CSI transmission and/or HARQ transmission.

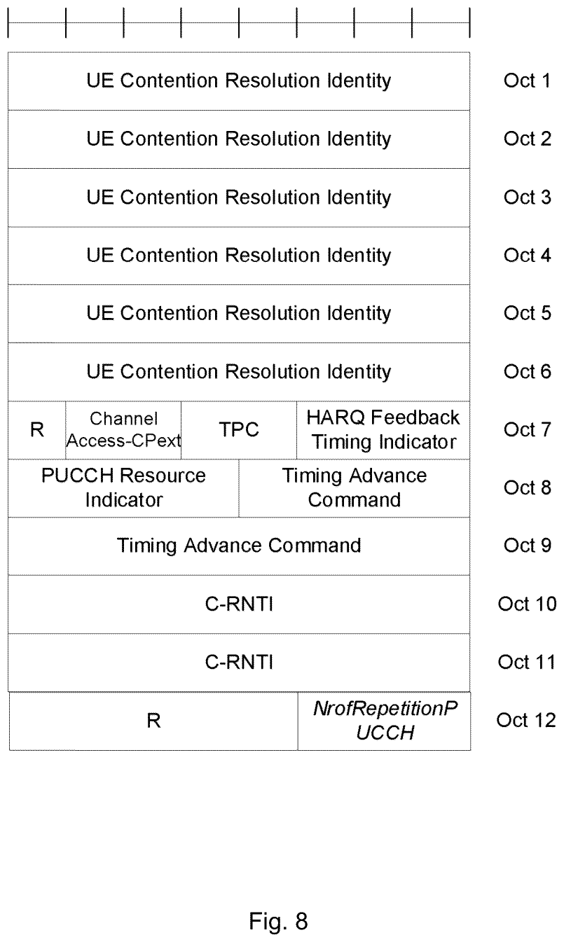

FIG. 8 is a schematic diagram illustrating an improved octet according to some embodiments of the present disclosure.

Some embodiments include PUCCH resources for carrying A-CSI triggered by RAR or in the corresponding DCI. While A-CSI may be triggered in normal downlink DCI as described in previous embodiments, A-CSI may also be triggered in RAR PDSCH or in DL fallback DCI (i.e., DCI format 1_0) in random access procedure when the UE can be either in idle/inactive or in RRC connected mode.

When a UE is in RRC idle/inactive mode or when the UE does not have the dedicated PUCCH resource configuration, the default PUCCH resource sets will be used, which are mainly defined for HARQ-ACK information transmission, meaning some updates to the existing common PUCCH resource sets may be beneficial for A-CSI transmission.

In particular embodiments, to support A-CSI transmission in common PUCCH resource sets, i.e. when PUCCH-ResourceSet in PUCCH-Config is not available, one or more of the following methods can be used.

Particular embodiments may use a separate table to define PUCCH resource sets before dedicated PUCCH resource configuration for A-CSI. For example, particular embodiments may use a new table similar to a previous table, but with more PUCCH formats, e.g. format 2, 3, 4 included as well to support A-CSI transmission with more than 2 bits.

Particular embodiments may use an updated table for A-CSI transmission before dedicated PUCCH resource configuration. For example, particular embodiments may use an additional column with PUCCH format and a column with number or PRBs for A-CSI on PUCCH to define A-CSI specific values. Note that “Set of initial CS indexes” is only appliable to PUCCH format 0 and 1, “NrofPRBs A-CSI” is only for PUCCH format 2 and 3.

| | | PUCCH | | | PRB | | Set of |
|---|---|---|---|---|---|---|---|
| | PUCCH | format | First | Number of | offset | NrofPRBs | initial CS |
| Index | format | A-CSI | symbol | symbols | RB_{BWP}^{offset} | A-CSI | indexes |
| 0 | 0 | 2 | 12 | 2 | 0 | 2 | {0, 3} |
| 1 | 0 | 2 | 12 | 2 | 0 | 4 | {0, 4, 8} |
| 2 | 0 | 2 | 12 | 2 | 3 | 8 | {0, 4, 8} |
| 3 | 1 | 2 | 13 | 1 | 0 | 2 | {0, 6} |
| 4 | 1 | 2 | 13 | 1 | 0 | 4 | {0, 3, 6, 9} |
| 5 | 1 | 2 | 13 | 1 | 2 | 8 | {0, 3, 6, 9} |
| 6 | 1 | 3 | 10 | 4 | 4 | 2 | {0, 3, 6, 9} |
| 7 | 1 | 3 | 4 | 10 | 0 | 4 | {0, 6} |
| 8 | 1 | 3 | 4 | 10 | 0 | 8 | {0, 3, 6, 9} |
| 9 | 1 | 3 | 4 | 10 | 2 | 16 | {0, 3, 6, 9} |
| 10 | 1 | 3 | 2 | 12 | 4 | 4 | {0, 3, 6, 9} |
| 11 | 1 | 3 | 2 | 12 | 0 | 8 | {0, 6} |
| 12 | 1 | 3 | 0 | 14 | 0 | 2 | {0, 3, 6, 9} |
| 13 | 1 | 3 | 0 | 14 | 2 | 4 | {0, 3, 6, 9} |
| 14 | 1 | 3 | 0 | 14 | 4 | 8 | {0, 3, 6, 9} |
| 15 | 1 | 3 | 0 | 14 | └N_{BWP}^{size}/4┘ | 16 | {0, 3, 6, 9} |

Some embodiments use separate PUCCH resource set indication and/or PUCCH resource indication within a selected PUCCH resource set. In one example, a 4-bit ACSI-pucch-ResourceCommon parameter may be defined in PUCCH-ConfigCommon IE for the determination of the PUCCH resource set for A-CSI transmission, as is illustrated below.

-- ASN1START
-- TAG-PUCCH-CONFIGCOMMON-START

| | |
|---|---|
| PUCCH-ConfigCommon ::= | SEQUENCE { |
| pucch-ResourceCommon | INTEGER (0..15) |

OPTIONAL, -- Cond InitialBWP-Only

| | |
|---|---|
| ACSI-pucch-ResourceCommon | INTEGER (0..15) |

OPTIONAL, -- Cond InitialBWP-Only

| | |
|---|---|
| pucch-GroupHopping | ENUMERATED { neither, enable, |

disable },

| | |
|---|---|
| hoppingId | INTEGER (0..1023) |

OPTIONAL, -- Need R

| | |
|---|---|
| p0-nominal | INTEGER (−202..24) |

OPTIONAL, -- Need R
...
}
-- TAG-PUCCH-CONFIGCOMMON-STOP
-- ASN1STOP

The ACSI-pucch-ResourceCommon parameter is an entry into a 16-row table where each row configures a set of cell-specific PUCCH resources/parameters for A-CSI transmission. The UE uses those PUCCH resources until it is provided with a dedicated PUCCH-Config (e.g., during initial access) on the initial uplink BWP. After the network provides a dedicated PUCCH-Config for that bandwidth part the UE applies that one instead of the one provided in this field.

In another example, a “A-CSI PUCCH resource indicator” parameter can be defined in DCI for the determination of the PUCCH resource in the PUCCH resource set for A-CSI transmission after Msg4 transmission, as is illustrated below.

The following information is transmitted by means of the DCI format 1_0 with CRC scrambled by TC-RNTI:
Identifier for DCI formats—1 bit. —The value of this bit field is always set to 1, indicating a DL DCI format.
Frequency domain resource assignment—┌log₂(N_{RB}^{DL,BWP}(N_{RB}^{DL,BWP}+1)/2)┐ bits
N_{RB}^{DL,BWP} is the size of CORESET 0
Time domain resource assignment—4 bits
VRB-to-PRB mapping—1 bit
Modulation and coding scheme—5 bits
New data indicator—1 bit
Redundancy version—2 bits
HARQ process number—4 bits
Downlink assignment index—2 bits, reserved
TPC command for scheduled PUCCH—2 bits
PUCCH resource indicator—3 bits
A-CSI PUCCH resource indicator—3 bits
PDSCH-to-HARQ_feedback timing indicator—3 bits
ChannelAccess-CPext—2 bits indicating combinations of channel access type and CP extension for operation in a cell with shared spectrum channel access; otherwise 0 bit.

In particular embodiments, a separate table or an updated table may be used to also support HARQ-ACK and CSI multiplexed in one PUCCH.

In particular embodiments, PUCCH-ResourceCommon is defined such that it supports both A-CSI with HARQ-ACK and A-CSI without HARQ-ACK.

Some embodiments include power control for A-CSI carrying PUCCH. In NR, closed loop transmit power control for PUCCH is done by sending transmit power control commands (TPCs) in DL DCI. A TPC bit field is contained in a DL DCI format 1_x for indicating a closed loop power adjustment for the PUCCH carrying HARQ-ACK. If different PUCCH resources are used/selected for HARQ-ACK and A-CSI triggered by the same DL DCI and if the two PUCCH resources are configured with different closed loop indices by the higher layer parameter closedLoopIndex, the TPC command in the DCI is for the HARQ-ACK carrying PUCCH resource.

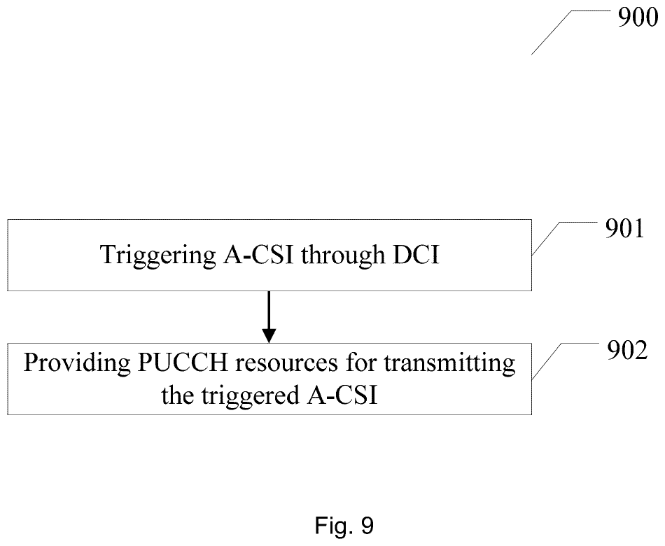

FIG. 9 is a flow chart illustrating a method 900 for providing PUCCH resources according to some embodiments. The method 900 may be performed in a network node by way of example only but it is not limited thereto.

In particular embodiments, the method 900 may begin with triggering A-CSI through DCI (block 901). Then, PUCCH resources for transmitting the triggered A-CSI may be provided (block 902).

As a further example, the DCI may include downlink related downlink control information (DL DCI).

As a further example, the PUCCH resources may be provided independently of channel state information (CSI) report configurations.

As a further example, the PUCCH resources may be provided through PUCCH configurations from a higher layer.

As a further example, it may be determined whether the triggered A-CSI is multiplexed with a hybrid automatic repeat request acknowledgement (HARQ-ACK) based on a HARQ-ACK response and a CSI report in the DL DCI prior to a mapping of the triggered A-CSI to the PUCCH resources.

As a further example, the DCI may include uplink related downlink control information (UL DCI), wherein a first PUCCH resource set may support a maximum payload size of more than 2 bits.

As a further example, the maximum payload size of more than 2 bits may be provided by higher layers.

As a further example, a PUCCH resource indication field included in the UL DCI may be increased to more than 3 bits.

As a further example, a PUCCH resource set comprising the PUCCH resources may be configured such that the number of the PUCCH resources is corresponding to the number of bits included in a field in the DCI for the PUCCH resources.

As a further example, the same PUCCH resource set configuration may be used to providing PUCCH resources for both a HARQ-ACK and the A-CSI.

As a further example, a PUCCH resource set configuration separate from a HARQ-ACK may be used to provide the PUCCH resources for the A-CSI.

As a further example, parameters in the separate PUCCH resource set configuration for the A-CSI may have different values than those for the HARQ-ACK.

As a further example, a maximum number of PUCCH resource sets may be increased to more than 4.

As a further example, the same PUCCH resource indicator field in the DL DCI may be used for both a HARQ-ACK and the A-CSI regardless of whether the A-CSI is multiplexed with the HARQ-ACK.

As a further example, a PUCCH resource for the A-CSI may be determined from a list of PUCCH resources. The determination may be based on the number of A-CSI reports on the PUCCH.

As a further example, the list associated with a HARQ-ACK having a priority index may be valid for an A-CSI having the same priority index.

As a further example, the PUCCH resources may be provided as part of CSI report configurations.

As a further example, a predetermined PUCCH resource of the PUCCH resources may be configured as part of a new CSI report configuration type.

As a further example, the PUCCH resource for the new CSI report configuration type may be periodic.

As a further example, a parameter indicating periodicity and a slot offset of the PUCCH resource may be configured as part of the new CSI report configuration type. The slot offset may provide a slot for the transmission of the PUCCH relative to slot timing of a physical downlink control channel (PDCCH) for the DCI.

As a further example, the A-CSI triggered by the DCI may be configured to repeat across slots.

As a further example, the number of repetitions may be provided by a field in the PUCCH resource. The number of repetitions may range from 1 to 8.

As a further example, the number of repetitions may be provided through CSI report configurations such that different CSI report configurations have different number of repetitions.

As a further example, the number of repetitions may be related to one or more of: a PUCCH format; whether the repetitions are within a slot or across slots or both; the number of physical resource blocks (PRBs); and whether inter-slot and/or intra-slot frequency hopping is enabled or not.

As a further example, the number of repetitions may be overwritten by a dynamically signaled number of repetitions provided in the DL DCI.

As a further example, the A-CSI may be triggered by a payload of a physical downlink shared channel (PDSCH).

As a further example, the A-CSI may be configured to repeat across slots.

As a further example, the number of repetitions may be provided in a field in the payload of the PDSCH other than a field for A-CSI.

As a further example, if predetermined PUCCH resource sets are unavailable, one or more of the following operations may be performed: providing a separate table for defining PUCCH resource sets prior to a dedicated PUCCH resource configuration; providing an updated table prior to the dedicated PUCCH resource configuration; and/or using a separate PUCCH resource set indication within a selected PUCCH resource set.

As a further example, the updated table may be provided by adding a column associated with a PUCCH format and a column associated with the number of PRBs.

As a further example, the separate table or the updated table may be used to also support a HARQ-ACK and the A-CSI multiplexed in the PUCCH.

As a further example, a parameter of PUCCH resource common may support both the A-CSI with a HARQ-ACK and the A-CSI without the HARQ-ACK.

As a further example, closed loop transmit power control for the PUCCH may be performed by transmitting transmit power control (TPC) commands in the DCI. A field for the TPC may be included in the DCI to indicate a closed loop power adjustment for the PUCCH carrying a HARQ-ACK.

As a further example, if different PUCCH resources are selected for a HARQ-ACK and the A-CSI triggered by the same DCI, and configured with different closed loop indices by a higher layer parameter, then the TPC command in the DCI may be configured for the HARQ-ACK.

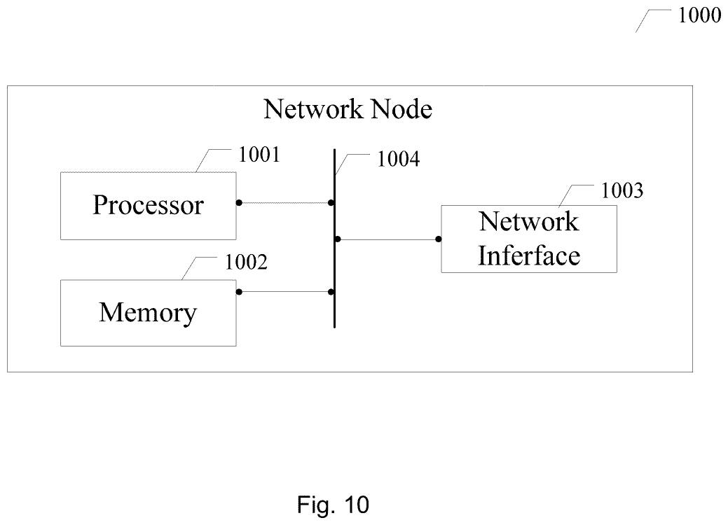

FIG. 10 is a block diagram illustrating a network node 1000 for providing PUCCH resources according to some embodiments. It should be appreciated that the network node 1000 may be implemented using components other than those illustrated in FIG. 10.

With reference to FIG. 10, the network node 1000 may comprise at least a processor 1001, a memory 1002, an interface 1003 and a communication medium 1004. The processor 1001, the memory 1002 and the interface 1003 may be communicatively coupled to each other via the communication medium 1004.

The processor 1001 may include one or more processing units. A processing unit may be a physical device or article of manufacture comprising one or more integrated circuits that read data and instructions from computer readable media, such as the memory 1002, and selectively execute the instructions. In various embodiments, the processor 1001 may be implemented in various ways. As an example, the processor 1001 may be implemented as one or more processing cores. As another example, the processor 1001 may comprise one or more separate microprocessors. In yet another example, the processor 1001 may comprise an application-specific integrated circuit (ASIC) that provides specific functionality. In still another example, the processor 1001 may provide specific functionality by using an ASIC and/or by executing computer-executable instructions.

The memory 1002 may include one or more computer-usable or computer-readable storage medium capable of storing data and/or computer-executable instructions. It should be appreciated that the storage medium is preferably a non-transitory storage medium.

The interface 1003 may be a device or article of manufacture that enables the network node 200 to send data to or receive data from external devices.

The communication medium 1004 may facilitate communication among the processor 1001, the memory 1002 and the interface 1003. The communication medium 1004 may be implemented in various ways. For example, the communication medium 1004 may comprise a Peripheral Component Interconnect (PCI) bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing System Interface (SCSI) interface, or another type of communications medium.

In the example of FIG. 10, the instructions stored in the memory 1002 may include those that, when executed by the processor 1001, cause the network node 1000 to implement the method described with respect to FIG. 9.

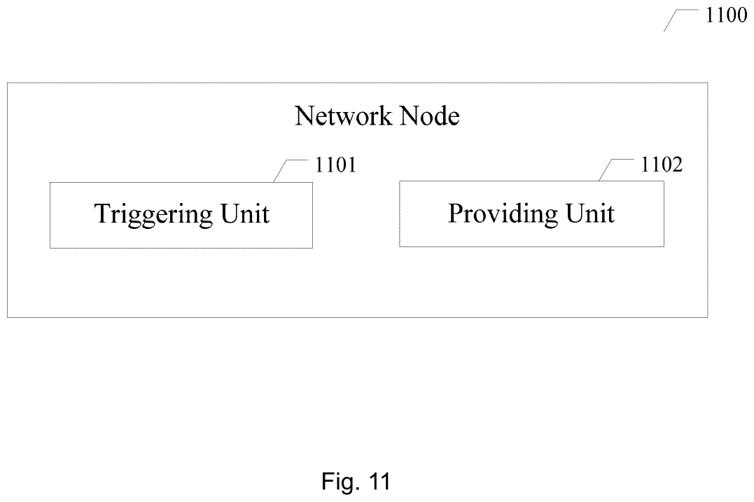

FIG. 11 is another block diagram illustrating a network node 1100 for providing PUCCH resources according to some embodiments. It should be appreciated that the network node 1100 may be implemented using components other than those illustrated in FIG. 11.

With reference to FIG. 11, the network node 1100 may comprise at least a triggering unit 1101 and a providing unit 1102. The triggering unit 1101 may be adapted to perform at least the operation described in the block 901 of FIG. 9. The providing unit 1102 may be adapted to perform at least the operation described in the block 902 of FIG. 9.

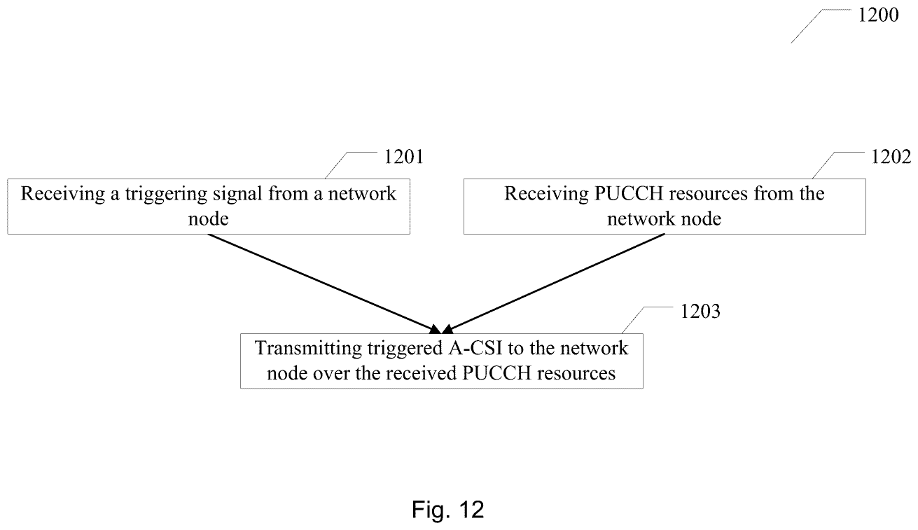

FIG. 12 is a flow chart illustrating a method 1200 for transmitting triggered A-CSI over the PUCCH resources according to some embodiments. The method 1200 may be performed in a user equipment by way of example only but it is not limited thereto.

In particular embodiments, the user equipment may receive a triggering signal from a network node (block 1201). PUCCH resources may be received from the network node (block 1202). The UE may transmit triggered A-CSI to the network node over the received PUCCH resources.

As a further example, the receiving of the triggering signal and the receiving of the PUCCH resources may performed simultaneously.

As a further example, the PUCCH resources may be provided according to the method 900 of FIG. 9.

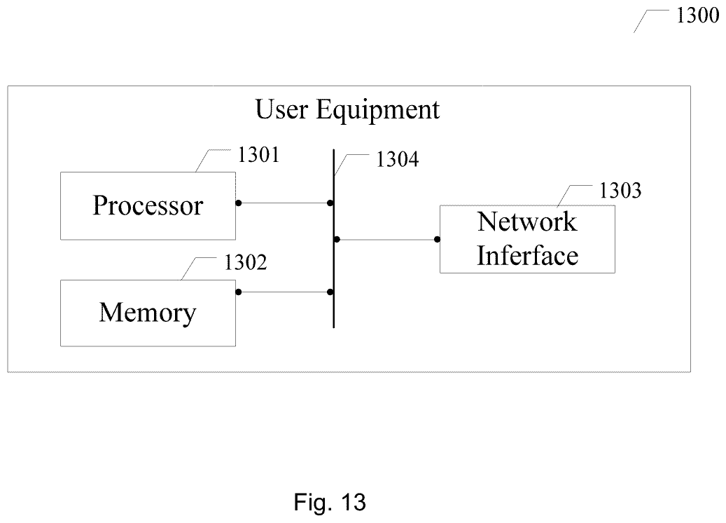

FIG. 13 is a block diagram illustrating a user equipment 1300 for transmitting triggered A-CSI over the PUCCH resources according to some embodiments of the present disclosure. It should be appreciated that the user equipment 1300 may be implemented using components other than those illustrated in FIG. 13.

With reference to FIG. 13, the user equipment 1300 may comprise at least a processor 1301, a memory 1302, an interface 1303 and a communication medium 1304. The processor 1301, the memory 1302 and the interface 1303 may be communicatively coupled to each other via the communication medium 1304.

The processor 1301, the memory 1302, the interface 1303 and the communication medium 1304 may be structurally similar to the processor 1001, the memory 1002, the interface 1003 and the communication medium 1004 respectively, and will not be described herein in detail.

In the example of FIG. 13, the instructions stored in the memory 1302 may include those that, when executed by the processor 1301, cause the user equipment 1300 to implement the method described with respect to FIG. 12.

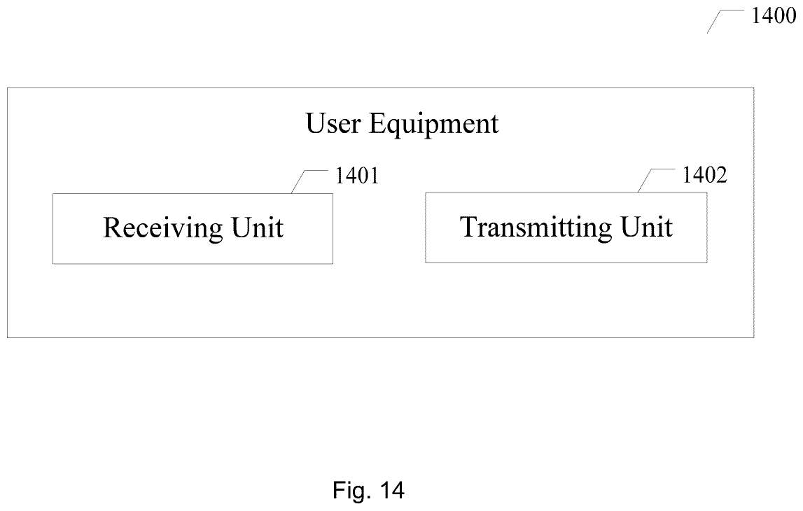

FIG. 14 is another block diagram illustrating a user equipment 1400 for transmitting triggered A-CSI over the PUCCH resources according to some embodiments of the present disclosure. It should be appreciated that the user equipment 1400 may be implemented using components other than those illustrated in FIG. 14.

With reference to FIG. 14, the user equipment 1400 may comprise at least a receiving unit 1401 and a transmitting unit 1402. The receiving unit 1401 may be adapted to perform at least the operations described in the blocks 1201 and 1202 of FIG. 12. The transmitting unit 1402 may be adapted to perform at least the operation described in the block 1203 of FIG. 12.

Some units are illustrated as separate units in FIGS. 11 and 14. However, this is to indicate that the functionality is separated. The units may be provided as separate elements. However, other arrangements are possible, e.g., some of them may be combined as one unit. Any combination of the units may be implemented in any combination of software, hardware, and/or firmware in any suitable location. For example, there may be more controllers configured separately, or just one controller for all of the components.

The units shown in FIGS. 11 and 14 may constitute machine-executable instructions embodied within e.g. a machine readable medium, which when executed by a machine will cause the machine to perform the operations described. Besides, any of these units may be implemented as hardware, such as an application specific integrated circuit (ASIC), Digital Signal Processor (DSP), Field Programmable Gate Array (FPGA) or the like.

Moreover, it should be appreciated that the arrangements described herein are set forth only as examples. Other arrangements (e.g., more controllers or more detectors, etc.) may be used in addition to or instead of those shown, and some units may be omitted altogether. Functionality and cooperation of these units are correspondingly described in more detail with reference to FIGS. 9 and 12.

Some portions of the foregoing detailed description have been presented in terms of algorithms and symbolic representations of transactions on data bits within a computer memory. These algorithmic descriptions and representations are ways used by those skilled in the signal processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be appreciated, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to actions and processes of a computer system, or a similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments of the present disclosure are not described with reference to any particular programming language. It should be appreciated that a variety of programming languages may be used to implement the teachings of embodiments of the present disclosure as described herein.

An embodiment of the present disclosure may be an article of manufacture in which a non-transitory machine-readable medium (such as microelectronic memory) has stored thereon instructions (e.g., computer code) which program one or more signal processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed signal processing components and fixed hardwired circuit components.

In the foregoing detailed description, embodiments of the present disclosure have been described with reference to specific example embodiments thereof. It will be evident that various modifications may be made thereto without departing from the spirit and scope of the present disclosure as set forth in the following claims. The specification and drawings are, accordingly, to be regarded in an illustrative sense rather than a restrictive sense.

Throughout the description, some embodiments of the present disclosure have been presented through flow diagrams. It should be appreciated that the order of transactions and transactions described in these flow diagrams are only intended for illustrative purposes and not intended as a limitation of the present disclosure. One having ordinary skill in the art would recognize that variations can be made to the flow diagrams without departing from the spirit and scope of the present disclosure as set forth in the following claims.

1. A method implemented by a network node in a communication network, the method comprising:
triggering one or more aperiodic channel state information (A-CSI) reports from a user equipment (UE) through downlink control information (DCI); and
providing to the UE information about a physical uplink control channel (PUCCH) resource for transmitting the triggered one or more A-CSI reports.

2.-13. (canceled)

14. A network node in a communication network, comprising:
a processor; and
a memory communicatively coupled to the processor and adapted to store instructions which, when executed by the processor, cause the network node to:
trigger one or more aperiodic channel state information (A-CSI) reports from a user equipment (UE) through downlink control information (DCI); and
provide to the UE information about a physical uplink control channel (PUCCH) resource for transmitting the triggered one or more A-CSI reports.

15. The network node of claim 14, wherein the PUCCH resource is provided independently of channel state information (CSI) report configurations for the one or more A-CSI reports.

16. The network node of claim 14, wherein the PUCCH resource is provided as part of CSI report configurations for the one or more A-CSI reports.

17. The network node of claim 14, wherein it is determined whether the triggered A-CSI is multiplexed with a hybrid automatic repeat request acknowledgement (HARQ-ACK) based on a HARQ-ACK response and a CSI report in the downlink DCI prior to a mapping of the triggered A-CSI to the PUCCH resources.

18. The network node of claim 14, wherein a PUCCH resource set of a plurality of PUCH resource sets supports a maximum payload size of more than 2 bits.

19. The network node of claim 14, wherein a PUCCH resource indication field included in the downlink DCI is greater than 3 bits.

20. The network node of claim 14, wherein a PUCCH resource set provides PUCCH resources for both a hybrid automatic repeat request acknowledgement (HARQ-ACK) and the A-CSI.

21. The network node of claim 14, wherein a PUCCH resource set configuration separate from a hybrid automatic repeat request acknowledgement (HARQ-ACK) resource set configuration is used for the A-CSI and wherein parameters in the separate PUCCH resource set configuration for the A-CSI have different values than those for the HARQ-ACK.

22. The network node of claim 21, wherein the parameters include a transmit power control (TPC) parameter.

23. The network node of claim 14, wherein a maximum number of PUCCH resource sets is greater than 4.

24. The network node of claim 14, wherein a parameter indicating a slot offset of the PUCCH resources is configured.

25. The network node of claim 24, wherein the slot offset provides a slot for the transmission of the PUCCH relative to slot timing of a physical downlink control channel (PDCCH) for the downlink DCI.

26. The network node of claim 14, wherein the A-CSI triggered by the downlink DCI is configured to repeat across slots.

27. A method implemented by a user equipment (UE) in a communication network, the method comprising:
receiving, from a network node, a triggering signal for sending one or more aperiodic channel state information (A-CSI) reports to the network node;
receiving, from a network node, information about a physical uplink control channel (PUCCH) resource for transmitting the one or more A-CSI reports to the network node; and
transmitting the one or more triggered A-CSI reports to the network node over the received PUCCH resources.

28.-39. (canceled)

40. A user equipment in a communication network, comprising:
a processor; and
a memory communicatively coupled to the processor and adapted to store instructions which, when executed by the processor, cause the user equipment (UE) to:
receive, from a network node, a triggering signal for sending one or more aperiodic channel state information (A-CSI) reports to the network node;
receive, from a network node, information about a physical uplink control channel (PUCCH) resource for transmitting the one or more A-CSI reports to the network node; and
transmit the one or more triggered A-CSI reports to the network node over the received PUCCH resources.

41. The user equipment of claim 40, wherein the receiving of the triggering signal and the receiving of the PUCCH resources are performed simultaneously.

42. The user equipment of claim 40, wherein the information of the PUCCH resource is received independently of channel state information (CSI) report configurations for the one or more A-CSI reports.

43. The user equipment of claim 40, wherein the PUCCH resources are received as part of CSI report configurations.

44. The user equipment of claim 40, wherein a PUCCH resource set of a plurality of PUCH resource sets supports a maximum payload size of more than 2 bits.

45. The user equipment of claim 40, wherein a PUCCH resource indication field included in the triggering signal is greater than 3 bits.

46. The user equipment of claim 40, wherein a PUCCH resource set provides PUCCH resources for both a hybrid automatic repeat request acknowledgement (HARQ-ACK) and the A-CSI.

47. The user equipment of claim 40, wherein a PUCCH resource set configuration separate from a hybrid automatic repeat request acknowledgement (HARQ-ACK) resource set configuration is used for the A-CSI and wherein parameters in the separate PUCCH resource set configuration for the A-CSI have different values than those for the HARQ-ACK.

48. The user equipment of claim 47, wherein the parameters include a transmit power control (TPC) parameter.

49. The user equipment of claim 40, wherein a maximum number of PUCCH resource sets is greater than 4.

50. The user equipment of claim 40, wherein a parameter indicating a slot offset of the PUCCH resources is configured.

51. (canceled)

52. (canceled)
